(19) United States
(12) Patent Application Publication
(10) Pub. No.: US 2005/0196591 A1
(43) Pub. Date: Sep. 8, 2005

(54) Casing structure of compressed wood

(75) Inventor: Tatsuya Suzuki, Tokyo (JP)

Correspondence Address: HOGAN & HARTSON L.L.P., 500 S. GRAND AVENUE, SUITE 1900, LOS ANGELES, CA, 90071-2611, US

(73) Assignee: OLYMPUS CORPORATION

(21) Appl. No.: 11/075,989

(22) Filed: Mar. 8, 2005

Related U.S. Application Data
(63) Continuation of application No. PCT/JP05/02674, filed on Feb. 15, 2005.

(30) Foreign Application Priority Data
Mar. 3, 2004 (JP) 2004-059272

(51) Int. Cl. B32B 1/00

(52) U.S. Cl. 428/174

(57) ABSTRACT

A casing structure of compressed wood that holds a predetermined object between a plurality of compressed wood pieces, wherein each of the compressed wood pieces has a main surface portion and side surface portions formed integrally around entire peripheral edges of the main surface portion and non-parallel with the main surface portion, and wood fiber directions in the main surface portions of the compressed wood pieces are substantially asymmetrical with respect to an opposing surface between the compressed wood pieces.

### CROSS-REFERENCE TO RELATED APPLICATIONS

The present application is a continuation of PCT/JP2005/002674 filed on Feb. 15, 2005, which claims priority to Japanese Patent Application No. 2004-059272, filed on Mar. 3, 2004.

### BACKGROUND OF THE INVENTION

1) Field of the Invention

The present invention relates to a casing structure using compressed wood.

2) Description of the Related Art

Conventionally, light metals (for example, aluminum, stainless steel, titanium, and magnesium) and synthetic resins (for example, acrylonitrile-butadiene-styrene (ABS), polycarbonate, and acrylic resins) are used as a material of a casing for electronic device (for example, a digital camera, a mobile phone, and an IC recorder). A casing formed of the above materials has a relatively small expansion/contraction rate to a temperature change and other external pressures, and the expansion/contraction rate thereof is approximately the same in all directions since such a casing is isotropic. However, when the casing is evaluated as an exterior packaging member, the casing is disadvantageous in that it has no individual characteristics because it has almost no individual difference. Further its design property is deteriorated because scratches and discoloring occur over a long term use.

To solve the above problems, the inventor has conceived of forming a casing with wood. The use of wood is advantageous in that it can provide an appropriate individual difference because of grains that differ from one another and further in that the change of surface color over a long term use serves to enhance a design property. However, when wood is used as the casing material as described above, the rigidity of the casing may not be good enough compared with the casings of the light metal and the synthetic resin. Although the thickness of the casing may be increased to compensate the deterioration of the rigidity, this is not suitable for a casing for electronic device in which downsizing is particularly required. One conventionally known method to improve the strength of wood material is compression processing. According to the method, wood is softened through water absorption and compressed while being fixed in a predetermined shape, and sliced in a direction of compression to be a plate-like primary fixed product. Subsequently, the primary fixed product is shaped into a product with a predetermined three-dimensional shape while being heated and made to absorb water, and fixed in the predetermined three-dimensional shape to be a final product (see, for example, Japanese Patent No. 3078452). According to another known method, softened wood is compressed and fixed (see, for example, Japanese Patent Application Laid-Open No. 11-77619). Accordingly, when these methods are used, the strength of wood might be enhanced without the increase in wall thickness.

### SUMMARY OF THE INVENTION

It is an object of the present invention to at least solve the problems in the conventional technology.

A casing structure of compressed wood that holds a predetermined object between a plurality of compressed wood pieces, according to one aspect of the present invention, wherein each of the compressed wood pieces has a main surface portion and side surface portions formed integrally around entire peripheral edges of the main surface portion and non-parallel with the main surface portion, and wood fiber directions in the main surface portions of the compressed wood pieces are substantially asymmetrical with respect to an opposing surface between the compressed wood pieces.

A casing structure of compressed wood that holds a predtermined object between a pair of compressed wood pieces, according to another aspect of the present invention, wherein each of the compressed wood pieces has a main surface portion formed in an substantially square shape and side surface portions formed integrally around four peripheral edges of the main surface portion and non-parallel with the main surface portion, and wood fiber directions in the main surface portions of the pair of compressed wood pieces are substantially asymmetrical with respect to an opposing surface between the pair of compressed wood pieces.

### BRIEF DESCRIPTION OF THE DRAWINGS

FIG. 1 is a perspective view of an electronic device using a casing structure of compressed wood according to a first embodiment of the present invention;

FIG. 2 is an exploded perspective view of the electronic device shown in FIG. 1;

FIG. 3 is a sectional view of the electronic device taken along a line A-A indicated by arrows of FIG. 1;

FIG. 4 is a perspective view that conceptually depicts a main surface portion;

FIG. 5 is an enlarged sectional view of a joint portion of FIG. 3;

FIG. 6 is a perspective view that depicts a joint structure;

FIG. 7 is a perspective view of shaping of a wood piece for a front panel according to the first embodiment;

FIG. 8 is a perspective-view of shaping of a wood piece for a rear panel according to the first embodiment;

FIG. 9 is a plan view of shaping of a wood piece according to the first embodiment;

FIG. 10 is a perspective view that depicts a compression process of the wood piece according to the first embodiment;

FIG. 11 is a longitudinal sectional view that sequentially depicts respective compression processes of the wood piece according to the first embodiment;

FIG. 12 is a longitudinal sectional view that sequentially depicts respective compression processes of the wood piece according to the first embodiment;

FIG. 13 is a longitudinal sectional view that sequentially depicts respective compression processes of the wood piece according to the first embodiment;

FIG. 14 is a perspective view of an electronic device using a casing structure of compressed wood according to a second embodiment of the present invention when the electronic device is viewed from a rear surface direction;

FIG. 15 is an exploded perspective view of the electronic device when a battery cover is removed;

FIG. 16 is a perspective view of an electronic device using a casing structure of compressed wood according to a third embodiment of the present invention when the electronic device is viewed from a rear surface direction; and

FIG. 17 is an exploded perspective view of the electronic device when a battery cover is removed.

### DETAILED DESCRIPTION

Exemplary embodiments of a forming apparatus relating to the present invention will be explained in detail below with reference to the accompanying drawings.

A casing structure of the compressed wood according to the first embodiment will be explained. In general, the main features of the casing structure according to the first embodiment reside in that: (1) the casing structure is used to hold a predetermined object between a plurality (pair) of compressed wood pieces; each of the compressed wood pieces has a main surface portion and side surface portions formed integrally along the entire peripheral edges of the main surface portion in a direction not parallel to the main surface portion; and the wood fiber directions in the main surface portions of the compressed wood pieces are substantially asymmetrical with respect to the opposing surface between the compressed wood pieces; and that (2) the wood fiber direction is the main surface portion of one of the compressed wood pieces is approximately orthogonal to the wood fiber direction in the main surface portion of the other compressed wood piece opposing to the above compressed wood piece.

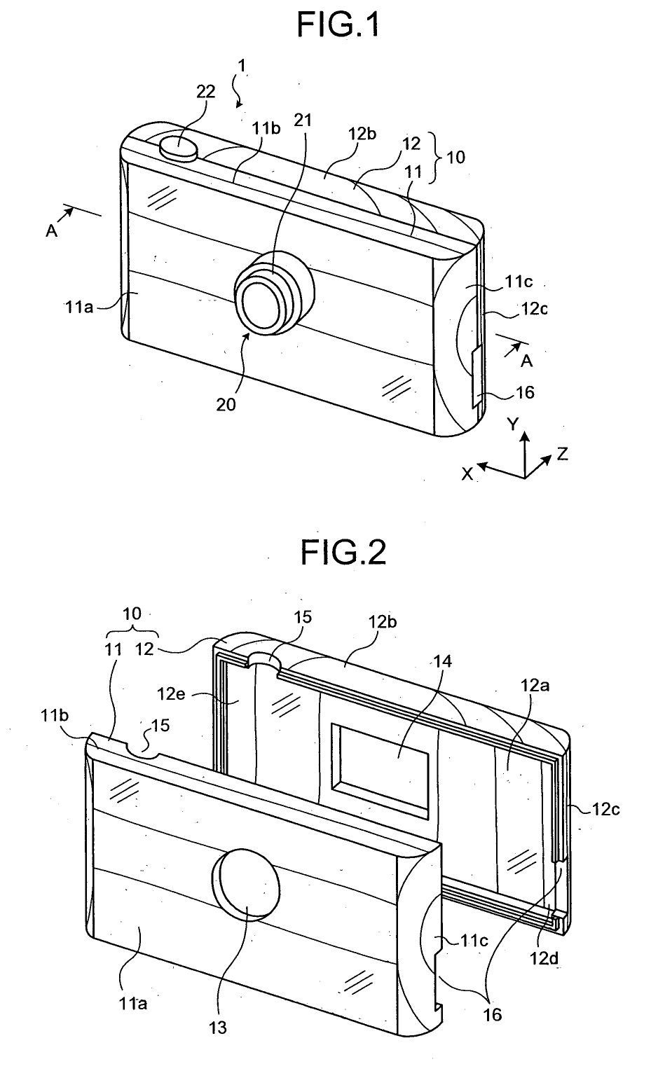

FIG. 1 is a perspective view of an electronic device using the casing structure of the compressed wood according to the first embodiment. In FIG. 1, the electronic device 1 is a digital camera including a casing 10 and an electronic unit 20. The casing 10 accommodates the electronic unit 20 as an object to be held in a holding space formed therein. The casing 10 holds the electronic unit 20 integrally therein as well as protects the electronic unit 20 from the outside of the casing 10. The casing 10 also serves as an exterior packaging member of the electronic device 1 through exposing the outer surface thereof to the outside.

The electronic unit 20 causes the electronic device 1 to implement necessary electronic functions and includes, for example, an imaging lens 21, a shutter button 22, a liquid crystal monitor, an image pickup device, a drive circuit for various devices, and terminals to be connected to external equipment. FIG. 1 depicts only the imaging lens 21 and the shutter button 22 among the components of the electronic unit 20.

As shown by arrows in FIG. 1, in the following explanation, a direction X along the long side of the electronic device 1 is called a longitudinal direction, a direction Y along a short side of the electronic device 1 and orthogonal to the longitudinal direction of the electronic device 1 is called a lateral direction, and a direction Z orthogonal to the longitudinal direction and the lateral direction is called a thickness direction. A dimension of the electronic device in the longitudinal direction is called a long size, a dimension thereof in the lateral direction is called a short size, and a dimension thereof in the thickness direction is called a thickness. The wood fiber direction is a direction in which a wood grows in a wood growing process (direction from a root of the wood to an extreme end thereof), that is, a direction which is substantially parallel with a flat grain surface and a straight grain surface, and substantially orthogonal to an end grain surface. Grain is generally a visible pattern formed by the gradation of wood fiber density. However, the term “grains” used herein indicates a distribution of wood fiber densities irrespective of the visibility.

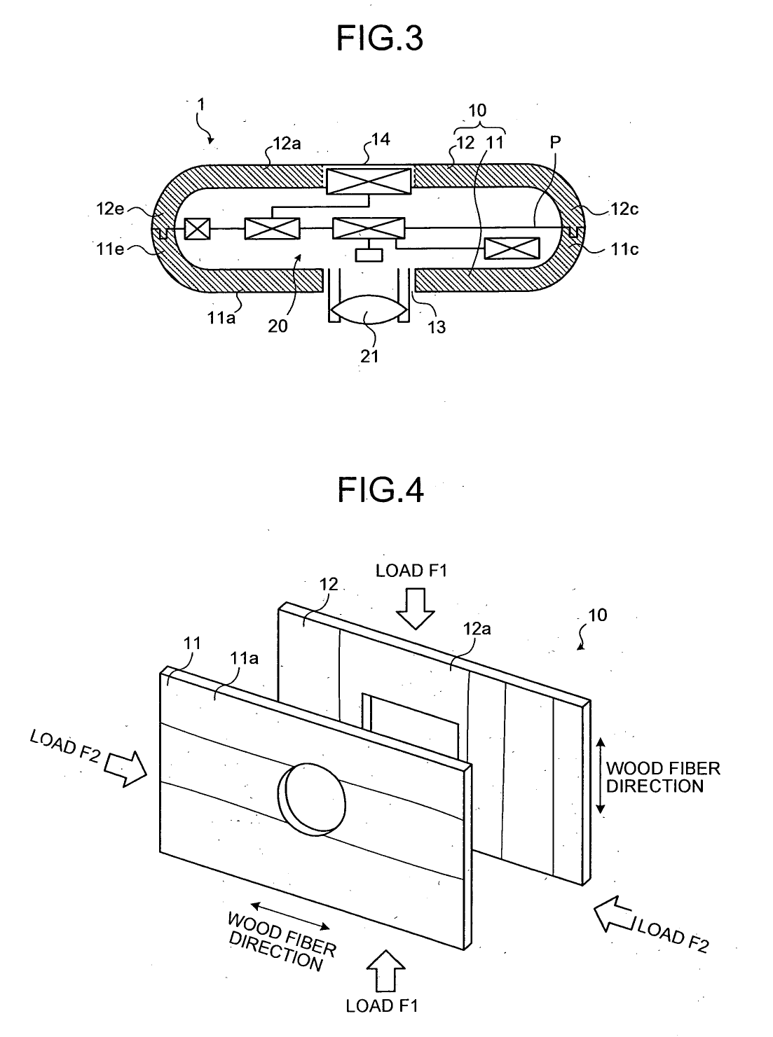

A specific structure of the casing 10 will be explained. FIG. 2 is an exploded perspective view of the electronic device 1 shown in FIG. 1, and FIG. 3 is a sectional view of the electronic device 1 shown in FIG. 1 taken along the line A-A of FIG. 1. The electronic unit 20 is not shown in FIG. 2. As shown in the respective figures, the casing 10 is composed of the plurality of compressed wood pieces combined with each other. In the first embodiment, the casing 10 is composed of a combination of a pair of compressed wood pieces, that is, a front panel 11 and a rear panel 12.

The front panel 11 and the rear panel 12 are formed and processed into a shape corresponding to the shape of the object to be held therein. In particular, the front panel 11 has a lens hole 13 for exposing the imaging lens 21 to the outside, and the rear panel 12 has a monitor hole 14 for exposing the liquid crystal monitor. Further, the front panel 11 and the rear panel 12 have a shutter hole 15 for exposing the shutter button 22 and a terminal hole 16 for allowing the connection terminal to be connected to the external equipment, respectively.

The front panel 11 has a flat main surface portion 11a and side surface portions 11b to 11e formed around the peripheral edges of the main surface portion 11a, and the rear panel 12 has a flat main surface portion 12a and side surface portions 12b to 12e formed around the peripheral edges of the main surface portion 12a. The side surface portions 11b to 11e and 12b to 12e are formed around all the peripheral edges of the main surface portions 11a and 12a, respectively. Since the main surface portions 11a and 12a are formed in a square shape and have the peripheral edges in four directions, the side surface portions 11b to 11e and 12b to 12e are formed around the four peripheral edges of the main surface portions 11a and 12a, respectively.

The side surface portions 11b to 11e and 12b to 12e are formed non-parallel with the main surface portions 11a and 12a, respectively. Specifically, the side surface portions 11b to 11e of the front panel 11 are arranged to rise toward the rear panel 12, and the side surface portions 12b to 12e of the rear panel 12 are arranged to rise toward the front panel 11. The angles between the main surface portions 11a and the side surface portions 11b to 11e and the angles between the main surface portions 12a and the side surface portions 12b to 12e can be set to arbitrary angles other than zero degree as long as they are non-parallel with each other. In the first embodiment, the side surface portions 11b to 11e and 12b to 12e are substantially orthogonal to the main surface portions 11a and 12a, respectively.

In particular, the side surface portions 11b to 11e and 12b to 12e are formed integrally with the main surface portions 11a and 12a, respectively. In other words, the side surface portions 11b to 11e and 12b to 12e are formed while continuously bending the wood fibers which are contained in the main surface portions 11a and 12a, in a non-parallel state therewith, respectively, by the pressure applied by a press or the like so that the wood fibers are not made discontinuous. In this regard, the casing 10 is essentially different from a conventional wooden box, a canoe which is formed by scraping, or the like.

The wood fiber directions of the front and rear panels 11 and 12 will be explained. When an imaginary opposing surface P interposed between the front panel 11 and the rear panel 12 is set as shown in FIG. 3, the wood fiber directions of the main surface portion 11a and side surface portions 11b to 11e are approximately asymmetrical with the wood fiber directions of the main surface portion 12a and the side surface portions 12b to 12e, respectively, with respect to the opposing surface P. Specifically, as to the front panel 11, the respective wood fibers of the main surface portions 11a and the side surface portions 11b to 11e are oriented along the longitudinal direction. On the other hand, as to the rear panel 12, the respective wood fibers of the main surface portions 12a and the side surface portions 12b to 12e are oriented along the lateral direction. In other words, the surfaces which confront with each other, that is, the main surface portions 11a and 12a, the side surface portions 11b and 12b, the side surface portions 11c and 12c, the side surface portions 11d and 12d, and the side surface portions 11e and 12e, are formed to have the wood fibers along a different direction.

In particular, in the first embodiment, the wood fiber direction in the main surface portion 11a of the front panel 11 is approximately orthogonal to that in the main surface portion 12a of the rear panel 12. The wood fiber direction of the main surface portion 11a is approximately parallel with the longitudinal direction, whereas the wood fiber direction of the main surface portion 12a is approximately orthogonal to the longitudinal direction (approximately parallel with the lateral direction). (Note that, in FIG. 3, though the cross sections of the front panel 11 and the rear panel 12 are shown by hatching, they do not denote either actual wood fibers or actual grains.) A method of forming the front and rear panels 11 and 12 as described above will be explained later.

An effect of disposing the wood fiber directions asymmetrically as described above will be explained. FIG. 4 is a perspective view that conceptually depicts the main surface portions 11a and 12a. Since the main surface portions 11a and 12a are members that affect the rigidity of the casing 10 most, only the main surface portions 11a and 12a are shown in FIG. 4. It is generally known that as for the strength of a wood it gets lower in the order of tensile strength, bending strength, compressive strength, and shear strength.

First, it is assumed that a load F1 is applied to the casing 10 from the directions shown by arrows. In this case, since the load F1 is approximately orthogonal to the wood fiber direction of the main surface portion 11a, a shear load is applied to the wood fibers in the main surface portion 11a (when both ends of the wood fibers are assumed to be fixed). Since the load F1 is approximately parallel with the wood fiber direction of the main surface portion 12a, a compressive load is applied to the wood fibers in the main surface portion 12a. Since the relation that compressive strength is higher than shear strength holds as described above, even if the load F1 cannot be sufficiently held by the main surface portion 11a, the load F1 can be held by the main surface portion 12a.

Next, it is assumed that a load F2 is applied to the casing 10 from the directions shown by arrows (directions approximately orthogonal to those of the load F1). In this case, since the load F2 is approximately parallel with the wood fiber direction of the main surface portion 11a, a compressive load is applied to the wood fibers in the main surface portion 11a. Since the load F2 is approximately orthogonal to the wood fiber direction of the main surface portion 12a, a shear load is applied to the wood fibers in the main surface portion 12a (when both ends of the wood fibers are assumed to be fixed). Since the relation that compressive strength is higher than shear strength holds as described above, even if the load F2 cannot be sufficiently held by the main surface portion 12a, the load F2 can be held by the main surface portion 11a.

As can be seen from the foregoing, the overall rigidity of the casing 10 can be improved because the load applied to the casing can be received by at least one of the main-surface portion 11a and the main surface portion 12a. In particular, in the first embodiment, since the wood fiber direction in the main surface portion 11a is approximately orthogonal to that in the main surface portion 12a, the above effect can be exhibited at the maximum. However, it is sufficient that the wood fiber directions of the main surface portions 11a and 12a be asymmetrical with each other, and the wood fiber direction in the main surface portion 11a need not be necessarily approximately orthogonal to that in the main surface portion 12a.

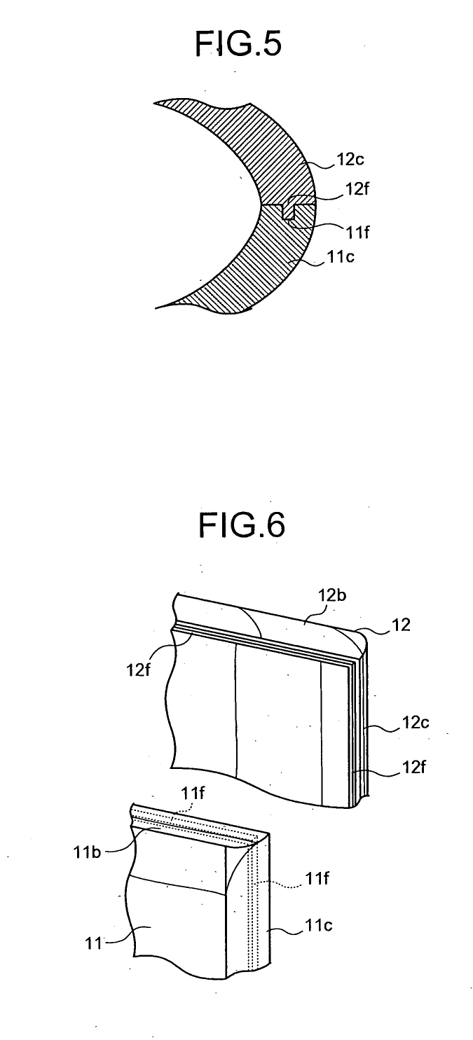

A joint structure of the front panel 11 and the rear panel 12 is explained next. FIG. 5 is an enlarged sectional view of a joint portion shown in FIG. 3, and FIG. 6 is a perspective view of the joint structure. As shown in FIGS. 5 and 6, a tenon portion 12f is formed around the entire periphery of the surface of the rear panel 12 facing the front panel 11. On the other hand, a mortise portion 11f, which has a shape corresponding to the tenon portion 12f, is formed around the entire periphery of the surface of the front panel 11 facing the rear panel 12. The front panel 11 is joined to the rear panel 12 through the insertion of the tenon portion 12f into the mortise portion 11f. Note that any joint structure may be employed between the front and rear panels 11 and 12, and a water-proof structure using a rubber packing may be employed.

A method of forming the front and rear panels 11 and 12 will be explained.

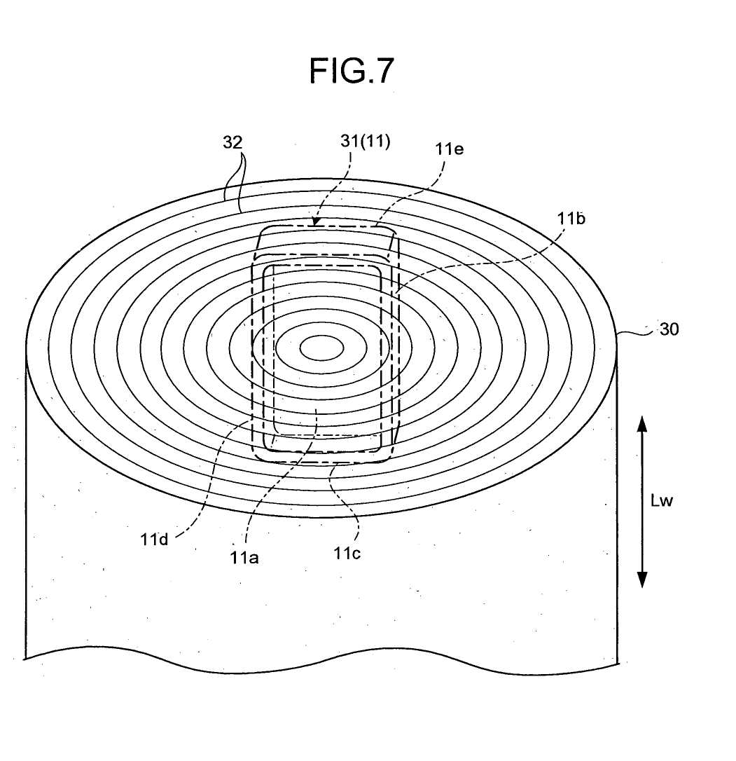

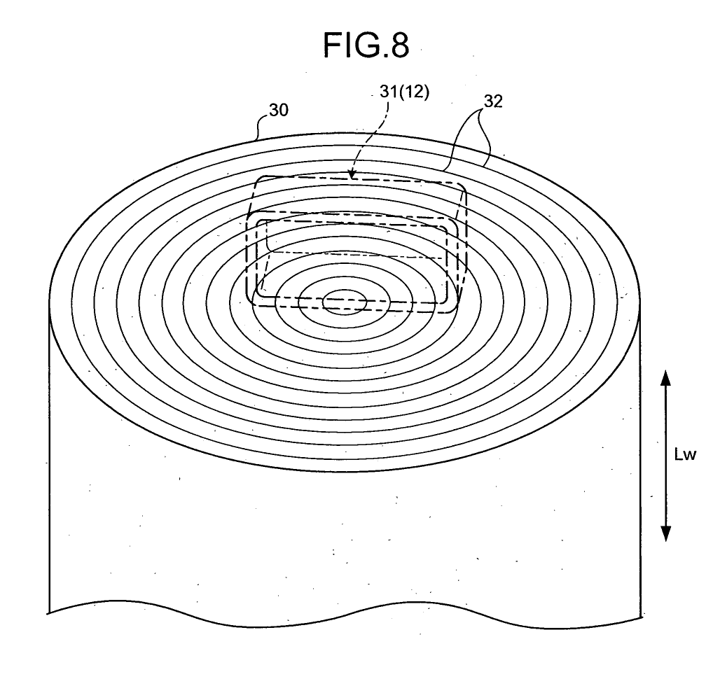

FIG. 7 is a perspective view of shaping of the wood piece for a front panel according to the first embodiment, and FIG. 8 is a perspective view of shaping of the Wood piece for a rear panel according to the first embodiment. As shown in FIGS. 7 and 8, a wood piece 31 is taken in a desired shape from an uncompressed raw wood 30. In FIGS. 7 and 8, the grains of the raw wood 30 are denoted by reference numeral 32.

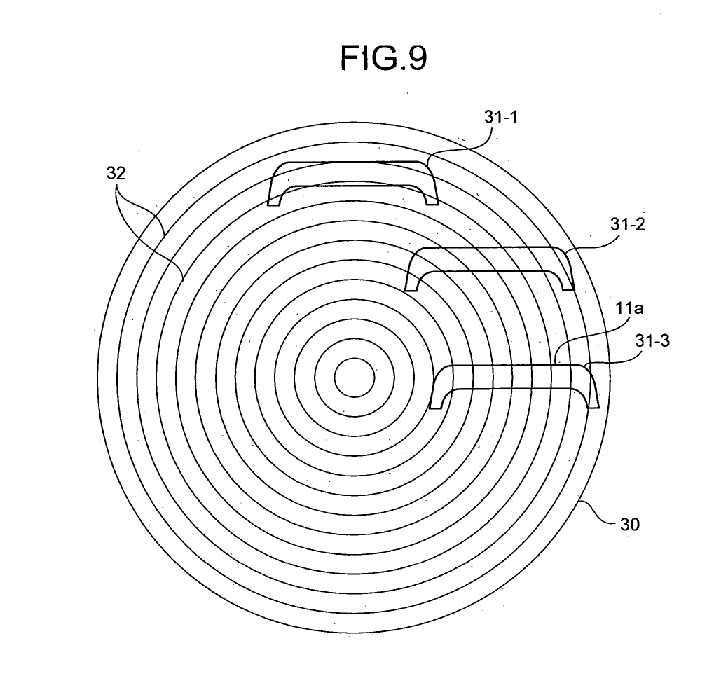

FIG. 9 is a plan view of shaping of a wood piece according to the first embodiment. As shown in FIG. 9, a wood piece 31-1, a wood piece 31-2, and a wood piece 31-3 can be taken as the wood piece 31 from the raw wood 30 according to a position with respect to the grain 32. In the first embodiment, the wood piece 31 for forming the front panel 11 is shaped at the position of the wood 31-1 shown in FIG. 9 so that the longitudinal direction thereof extends along a wood fiber direction Lw of the raw wood 30 as shown in FIG. 7. Further, the wood piece 31 for forming the rear panel 12 is shaped at the position of the wood piece 31-1 shown in FIG. 9 so that the longitudinal direction thereof extends in a direction approximately orthogonal to the wood fiber direction Lw of the raw wood 30 as shown in FIG. 8. Since the front and rear panels 11 and 12 can be formed in the same manner in the subsequent processes, the method of forming the front panel 11 alone is explained below.

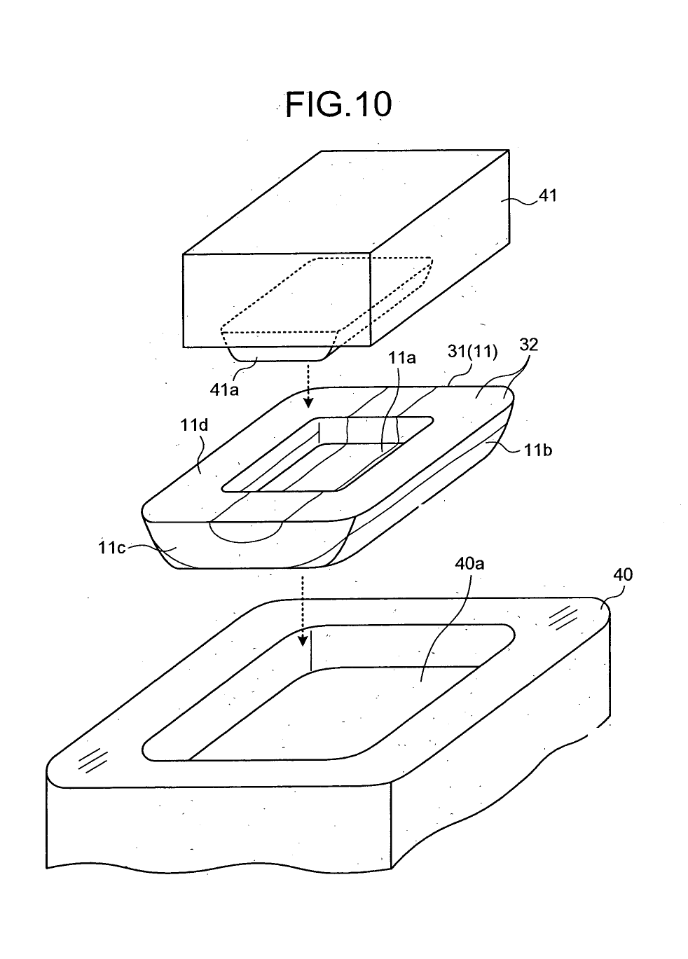

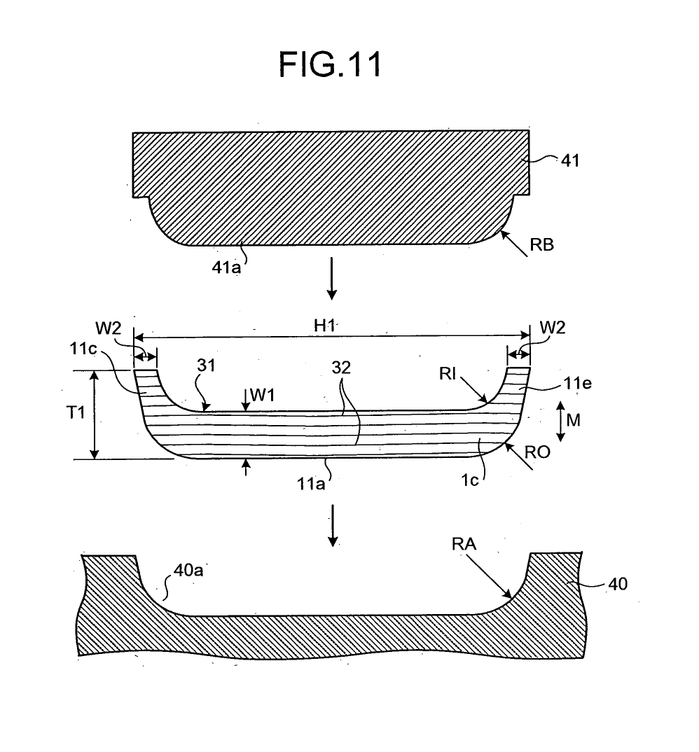

FIG. 10 is a perspective view of a compression process of the wood piece according to the first embodiment, and FIGS. 11 to 13 are longitudinal sectional views that sequentially depict respective compression processes of the wood piece according to the first embodiment. To briefly explain, the front panel 11, which includes the main surface portion 11a and the side surface portions 11b to 11e integrally therewith, is formed through the pressing of the wood piece 31 between a lower mold frame 40 and an upper mold frame 41 as shown in FIG. 10.

A shape of the wood piece 31 is explained first. The wood piece 31 is lumbered in a shape to which the volume of the wood piece 31 to be reduced by compression is previously added. Specifically, as shown in FIG. 11, the main surface portion 11a is shaped so as to have a thickness W1 to which the volume thereof reduced by compression is previously added, and the side surface portions 11b to 11e are shaped so as to have a thickness W2 and a height T1 to which the volume thereof reduced by compression is previously added, respectively. The front panel 11 is shaped to have a width H1 as a whole. The thickness W1 of the main surface portion is made larger than the thickness W2 of the side surface portions.

The relation between the shape of the wood piece 31 and the shapes of the lower and upper mold frames 40 and 41 is explained next. As shown in FIGS. 11 to 13, the relation between the radius of curvature of an outside curved surface RO of the wood piece 31 and the radius of curvature of a curved surface RA of a concave portion 40a of the lower mold frame 40 opposing the curved surface RO is shown by RO>RA. On the other hand, the relation between the radius of curvature of a curved surface RI of the wood piece 31 and the radius of curvature of a curved surface RB of a convex portion 41a of the upper mold frame 41 is shown by RI>RB. Further, as shown in FIG. 12, a space which is formed between the lower mold frame 40 and the upper mold frame 41 when they are combined with each other, has a shape corresponding to the shape of the front panel 11 after the compression of the wood piece 31.

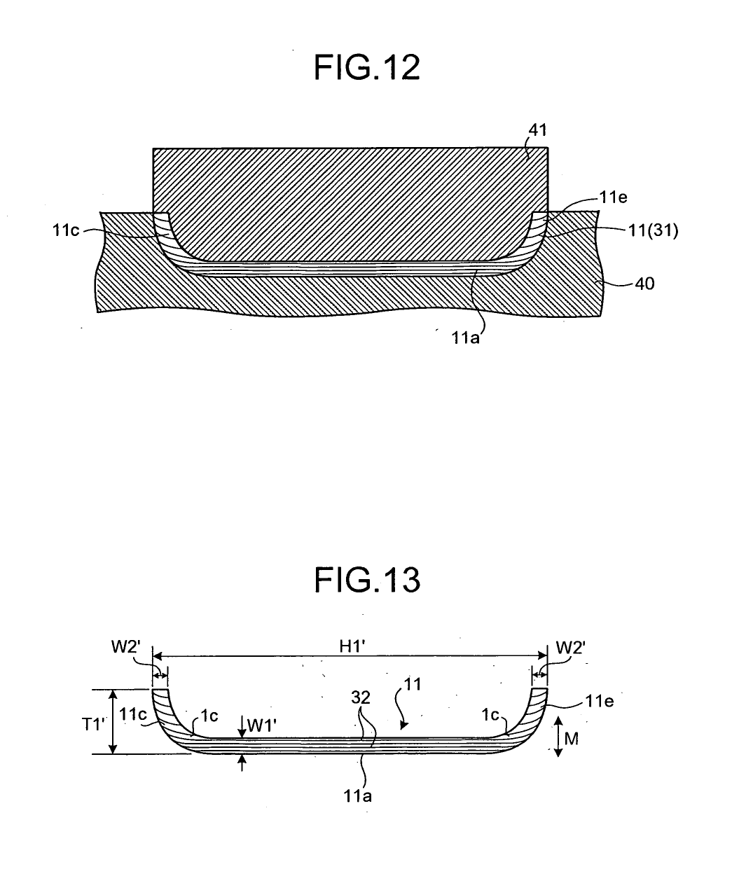

A specific forming method is explained next. First, as shown in FIG. 11, the wood piece 31 is placed between the lower mold frame 40 and the upper mold frame 41. At the same time, the wood piece 31 is placed in a water vapor atmosphere of high temperature and high pressure for a predetermined time so that it is softened by excessive absorption of moisture. Next, as shown in FIG. 12, the upper mold frame 41 is fitted into the lower mold frame 40 to compress the wood piece 31. Then, the wood piece 31 is left as it is for a predetermined period of time in a state that a compression force is applied thereto. Finally, the wood piece 31 is released from the water vapor atmosphere of high temperature and high pressure, and the thus formed front panel 11 is taken out by separating the upper mold frame 41 from the lower mold frame 40 as shown in FIG. 13. The taken-out front panel 11 has been compressed so that the main surface portion 11a and the side surface portions 11b to 11e have substantially uniform thicknesses W1′ and W2′, respectively, and the side surface portions 11b to 11e have a height T1′. Further, curved portions 1c are compressed obliquely. The front panel 11 is compressed to have a width H1′as a whole. The front panel 11, which is formed by compression as described above, is provided with a high strength in its entirety because the fiber density thereof is increased.

The second embodiment is explained next. A main feature of the second embodiment is such that a part of a compressed wood piece is formed as a detachable unit that is detachably mounted on the compressed wood piece, and the wood fiber direction of the detachable unit is substantially in coincidence with that of the compressed wood piece on which the detachable unit is mounted, in addition to the features of the first embodiment. Note that a structure and a method of the second embodiment are the same as those of the first embodiment described above unless explained otherwise, and like reference numerals designate like components as those of the first embodiment.

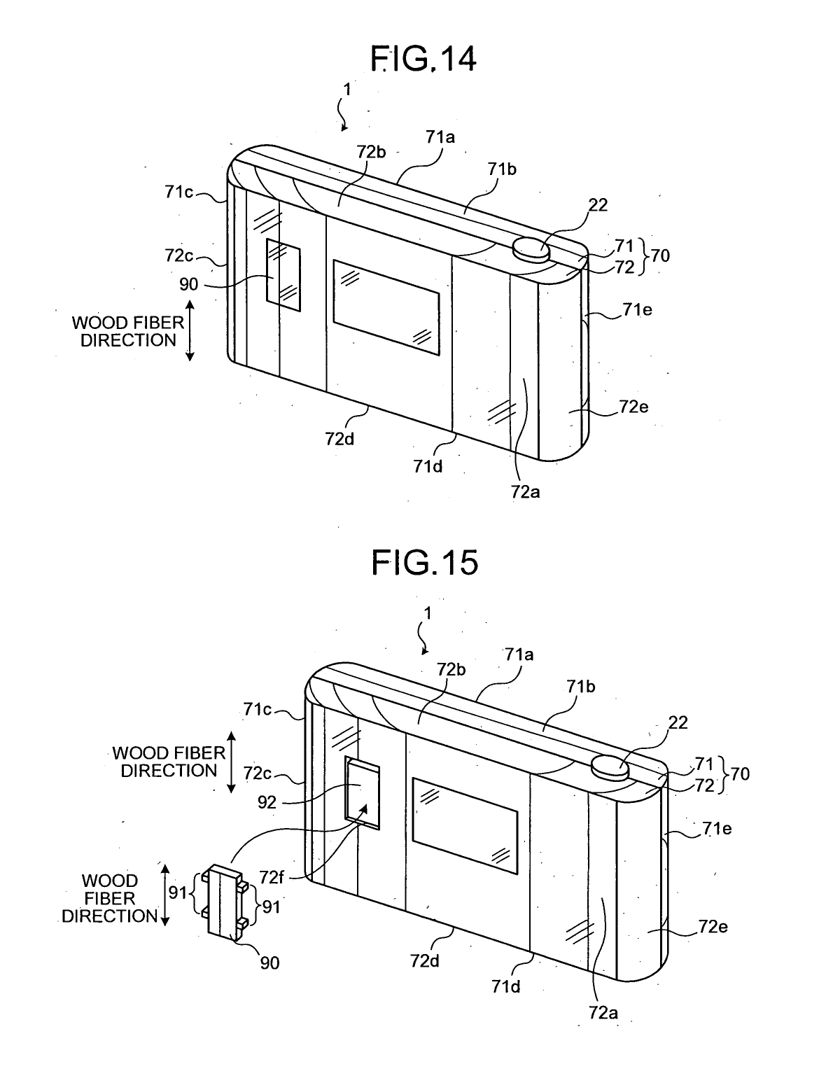

FIG. 14 is a perspective view from the back of an electronic device using the casing structure of the compressed wood according to the second embodiment, and FIG. 15 is an exploded perspective view of the electronic device when a battery cover is removed. As shown in the drawings, a casing 70 is composed of a pair of compressed wood pieces, that is, a front panel 71 and a rear panel 72 combined with each other.

The front panel 71 has a flat main surface portion 71a and side surface portions 71b to 71e integrally formed around the four peripheral edges of the main surface portion 71a non-parallel therewith, and the rear panel 72′ has a flat main surface portion 72a and side surface portions 72b to 72e integrally formed around the four peripheral edges of the main surface portion 72a non-parallel therewith. The wood fiber directions of the main surface portions 71a and 72a and the side surface portions 71b to 71e and 72b to 72e are substantially asymmetrical with respect to an opposing surface P (not shown) between the front and rear panels 71 and 72.

The rear panel 72 is provided with a battery cover 90 as a detachable unit which is detachably mounted thereon. A part of the main surface portion 72a of the rear panel 72 is cut in square to form the battery cover 90. The battery cover 90 is detachable from the main surface portion 72a by locking/unlocking of locking portions 91 formed on both sides of the battery cover 90 to/from the side edges of an opening 72f of the main surface portion 72a. A known structure can be employed as a specific locking structure. A battery 92 can be replaced by detaching the battery cover 90 from the main surface portion 72a as shown in FIG. 15.

The wood fiber direction of the battery cover 90 is approximately the same as the wood fiber direction of the main surface portion 72a on which the battery cover 90 is detachably mounted. In other words, as shown by an arrow in FIG. 14, the battery cover 90 is formed and disposed so that the wood fiber direction of the battery cover 90 is approximately the same as the lateral direction of the main surface portion 72a. Accordingly, since the main surface portion 72a and the battery cover 90 maintain the same wood fiber direction, the casing structure according to the second embodiment can improve the rigidity of a casing like that according to the first embodiment.

The third embodiment is explained next. A main feature of the third embodiment is such that the wood fiber direction of a detachable unit is substantially in coincidence with that of the compressed wood piece on which the detachable unit is mounted like the second embodiment. Note that a structure and a method of the third embodiment are the same as those of the second embodiment described above unless explained otherwise, and like reference numerals designate like components as those of the second embodiment.

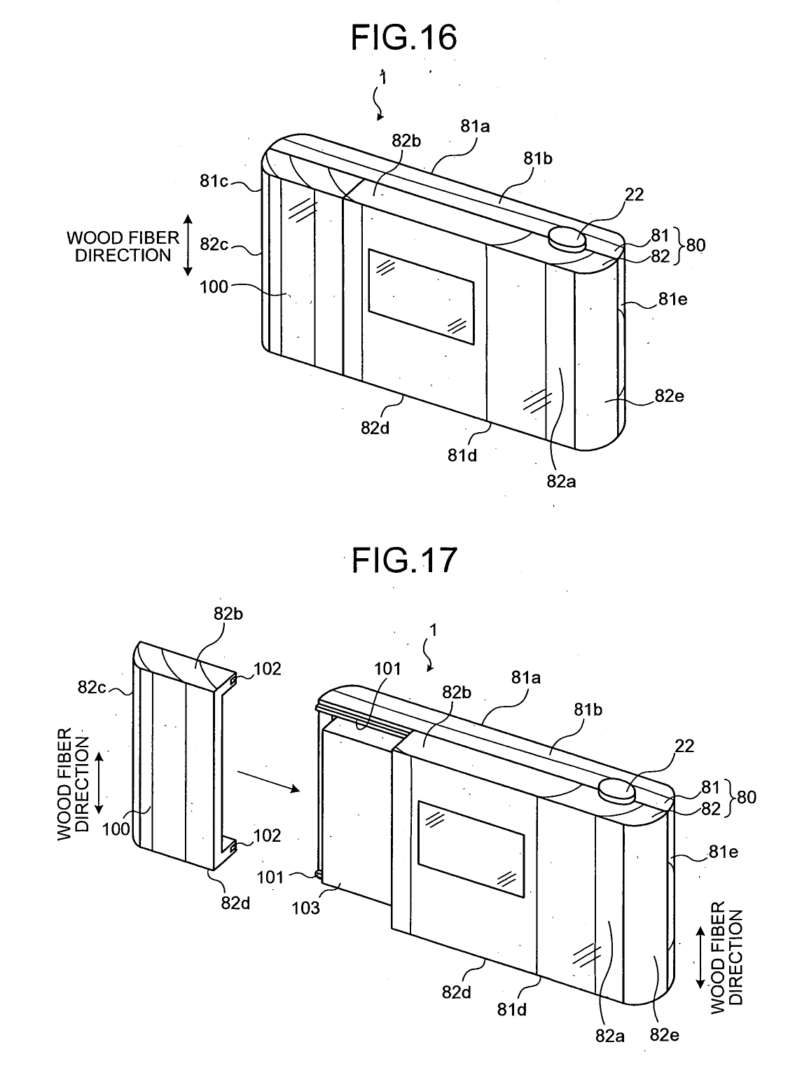

FIG. 16 is a perspective view of an electronic device using the casing structure of the compressed wood according to the third embodiment as viewed from the rear surface direction, and FIG. 17 is an exploded perspective view of the electronic device when the battery cover is removed. As shown in the drawings, a casing 80 is composed of a pair of compressed wood pieces, that is, a front panel 81 and a rear panel 82 combined with each other.

The front panel 81 has a flat main surface portion 81a and side surface portions 81b to 81e integrally formed around the four peripheral edges of the main surface portion 81a non-parallel therewith, and the rear panel 82 has a flat main surface portion 82a and side surface portions 82b to 82e integrally formed around the four peripheral edges of the main surface portion 82a non-parallel therewith. The wood fiber directions of the main surface portions 81a and 82a and the side surface portions 81b to 81e and 82b to 82e are substantially asymmetrical with respect to an opposing surface P (not shown) between the front and rear panels 81 and 82.

The rear panel 82 is provided with a battery cover 100 as a detachable unit detachably mounted thereon. One end of the rear panel 82 is divided to form the battery cover 100. In particular, the battery cover 100 is composed of parts of the main surface portion 82a and the side surface portions 82b and 82d of the rear panel 82 and the entire side surface portion 82c thereof.

A tenon portion 101 is formed on the surface of the front panel 81 facing the battery cover 100, and a mortise portion 102 having a shape corresponding to that of the tenon portion 101 is formed on the surface of the battery cover 100 facing the front panel 81. The battery cover 100 can be mounted as shown in FIG. 16 by sliding it while inserting the tenon portion 101 into the mortise portion 102. A known structure can be employed as a specific mounting structure. A battery 103 can be replaced by detaching the battery cover 100 from the rear panel 82 as shown in FIG. 17.

The wood fiber direction of the battery cover 100 is approximately the same as the wood fiber direction of the rear panel 82. In other words, the battery cover 100 is formed and disposed so that the wood fiber direction thereof is approximately the same as the lateral direction of the rear panel 82. Accordingly, since the main surface portion 82 and the battery cover 100 maintain the same wood fiber direction. The casing structure according to the third embodiment can improve the rigidity of a casing like that according to the first embodiment.

Finally, a possibility of modifying the above embodiments is explained. The specific structures and methods of the above embodiments according to the present invention described above can be arbitrarily modified and improved within the range of the technical spirits of inventive concept defined in the appended claims. Further, the problem to be solved by the present invention and the effect achieved by the present invention are not limited to those described above, and it is possible to solve a problem that is not described above and to achieve an effect that is not described above, and it is also possible to solve only a part of the problem described and to achieve only a part of the effect described above.

For example, the electronic device is not limited to the digital camera described above and may be arranged as a mobile phone, an IC recorder, a personal digital assistant (PDA), a portable television, a portable radio, a remote controller for various home electric appliances. In the above explanation, the terms such as “parallel” and “orthogonal” are used to describe the structure. These descriptions, however, do not mean strictly parallel and orthogonal, and the structures described as such may be non-parallel and non-orthogonal to an extent that would allow the structures to exert the advantageous function of the invention. In particular, since wood, which is a natural material is used in the structures, at least an error which may occur in an ordinary processing of wood is permitted. Further, the sizes and the rates of the various portions explained in the particular embodiments are only examples, and the respective portions may be formed to have any arbitrary sizes and rates different from those described above.

The casing structure may be composed of any arbitrary number of compressed wood pieces, and it may be composed of, for example, two to four compressed wood pieces combined together. Further, the compressed wood pieces may be formed in any arbitrary shape, and the casing composed of a combination of the compressed wood pieces may be formed in any arbitrary shape such as a cylindrical shape or an egg shape. The method of forming the compressed wood piece is not limited to the method explained above, and, for example, compression and forming of upwardly curved side surface portions may be simultaneously performed on a wood piece which is cut off in a flat shape, through the application of pressure thereon between the mold frames. Alternatively, the wood may be compressed in a direction other than the direction described above or may be compressed from a plurality of directions.

Further, the casing may be formed by indirectly combining the compressed wood pieces, except by directly combining them. For example, a plurality of the compressed wood pieces may be combined with each other with other metal or resin member fitted therebetween. Further, the detachable unit detachably mounted on the compressed wood piece is not limited to the battery cover as described in the second and the third embodiments, and it may be arranged as a detachable unit for achieving an arbitrary function.

In some cases, a mere compression processing of each wooden pieces would not secure the rigidity of a casing as a whole. Most casings for an electronic device are composed of plural pieces of compressed wood joined with each other. Accordingly, even if the rigidity of the individual pieces of compressed wood is improved, the rigidity of the casing as a whole may not be secured if the assembly structure of the pieces of compressed wood is not appropriate. For example, a casing might be formed of a pair of compressed wood pieces, of which fiber directions are arranged to be parallel to each other. Then, when a load is applied to the casing in a direction in which one piece of compressed wood has the lowest strength with respect to the wood fiber direction thereof (the direction orthogonal to the wood fiber direction), the load is also applied to the other piece in a direction in which the other piece has the lowest strength with respect to the wood fiber direction thereof because the wood fiber directions of the pair of compressed wood pieces are parallel with each other. Accordingly, since the load is applied to both compressed wood pieces in the weakest directions thereof, the casing as a whole might not be able to bear the load. Then, the casing might be deformed to generate gaps between the compressed wood pieces. Further, if excessive stress is applied to the junction of two pieces, cracks or other damages might be caused along the junction. When an electronic device includes a high voltage unit (for example, an electronic flash unit in a digital camera), it may be difficult to insulate the high voltage unit from the exterior of the device. In particular, when the gaps are generated in the casing, a creepage distance for insulation (shortest distance along a surface of an insulator between two conductive components) is shortened between the high voltage unit and the exterior of the device, which is not preferable because it may make it difficult to secure a predetermined creepage distance for insulation regulated by a safety standard.

On the other hand, in the casing structure of compressed wood according to the embodiments, a load applied to the casing can be received by the plurality of compressed wood pieces each having wood fibers in a different direction. Therefore, the load can be firmly received by at least some of the compressed wood pieces, whereby the overall rigidity of the casing of the compressed wood is improved. In the casing structure of the compressed wood the embodiments, a load applied to a casing can be received by the pair of compressed wood pieces each having wood fibers in a different direction. Therefore, the load can be firmly received by at least one of the compressed wood pieces, whereby the overall rigidity of the casing of the compressed wood is improved. In the casing structure of the compressed wood of the embodiments, even if a load is applied to some of the compressed wood pieces in the weakest direction thereof, since the load is applied to the other compressed wood piece in the strongest direction thereof, the load can be firmly received by the other compressed wood piece. Therefore, the overall rigidity of the casing of the compressed wood is improved. In the casing structure of the compressed wood of the embodiments, even if the detachable unit is provided in a part of the compressed wood piece, the wood fiber direction of the detachable unit can be matched with the wood fiber direction of the compressed wood piece on which the detachable unit is detachably mounted. Therefore, wood fiber directions suitable for improving the rigidity of the casing of the compressed wood can be maintained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A casing structure of compressed wood that holds a predetermined object between a plurality of compressed wood pieces, wherein each of the compressed wood pieces has a main surface portion and side surface portions formed integrally around entire peripheral edges of the main surface portion and non-parallel with the main surface portion, and wood fiber directions in the main surface portions of the compressed wood pieces are substantially asymmetrical with respect to an opposing surface between the compressed wood pieces.

2. A casing structure of compressed wood that holds a predtermined object between a pair of compressed wood pieces, wherein each of the compressed wood pieces has a main surface portion formed in an substantially square shape and side surface portions formed integrally around four peripheral edges of the main surface portion and non-parallel with the main surface portion, and wood fiber directions in the main surface portions of the pair of compressed wood pieces are substantially asymmetrical with respect to an opposing surface between the pair of compressed wood pieces.

3. The casing structure of compressed wood according to claim 1, wherein the wood fiber direction of the main surface portion of one compressed wood piece is substantially orthogonal to the wood fiber direction of the main surface portion of another compressed wood piece opposing the one compressed wood piece.

4. The casing structure of compressed wood according to claim 1, wherein a part of a compressed wood piece is formed as a detachable unit detachably mounted on the compressed wood piece, and a wood fiber direction of the detachable unit is substantially in coincidence with the wood fiber direction of the compressed wood piece on which the detachable unit is mounted.
